(19) United States
(12) Patent Application Publication
(10) Pub. No.: US 2009/0265777 A1
(43) Pub. Date: Oct. 22, 2009

(54) COLLABORATIVE AND PROACTIVE DEFENSE OF NETWORKS AND INFORMATION SYSTEMS

(75) Inventor: Brett Lester Scott, Gilbert, AZ (US)

Correspondence Address: JENNINGS, STROUSS & SALMON, P.L.C., 201 E. WASHINGTON ST., 11TH FLOOR, PHOENIX, AZ, 85004, US

(73) Assignee: Zytron Corp., Scottsdale, AZ (US)

(21) Appl. No.: 12/427,682

(22) Filed: Apr. 21, 2009

Related U.S. Application Data
(60) Provisional application No. 61/046,497, filed on Apr. 21, 2008.

(51) Int. Cl. G06F 21/00

(52) U.S. Cl. 726/11

(57) ABSTRACT

Collaborative and proactive defense of networks and information systems. The present examples of collaborative and proactive defense of networks and information systems provides a way of protecting computer networks from hackers by stopping them from entering a protected network. Protection may be include processes that utilize communications between layers in a communications protocol stack, or its equivalent to identify threats. Identified threats may be profiled and stored in a local and/or network database that may be shared among other subscribers. Once a threat is identified it may be blocked, redirected or otherwise processed to thwart, identify, or otherwise deal with the threat. Such protection may be termed the collaborative and proactive defense of networks and information systems.

### CROSS-REFERENCE TO RELATED APPLICATION(S)

This application claims the benefit of U.S. Provisional Patent Application No. 61/046,497 filed Apr. 21, 2008, the contents of which are hereby incorporated by reference.

### TECHNICAL FIELD

This description relates generally to computer systems and more specifically to the security of computer systems.

### BACKGROUND

A computer network typically include one or more networked computers that may be coupled together through various communications channels, including wired connections, wireless connections and the like. Individual computer networks (such as local area networks) and individual computers may be coupled together via further network connections. An example of a popular network is the internet (or wide area network). As the technology advances with the growth in availability of network connections, more computers and local area networks are able to be coupled together through the various network connections that may now be available. Also, the number of computers that have access to each other within networks has grown as higher transmission speeds and increases in network bandwidth are developed. As these networked connections have developed they have been used to increasing commercial advantage in such applications as e-commerce, and the exchange of information, including sensitive information, between various geographically dispersed locations.

Another trend has been an increase in the types of devices that may be networked. Many hardware devices are now often provided with processing and networking capability for communicating over the internet. For example, electrical power grid may be controlled by computer via a network infrastructure such as the internet. Another example is consumer electronics devices coupled to the internet to exchange or play digital media, such as music and video.

Unfortunately as computer network technology has developed, and new uses have been found to use the internet for legitimate commercial, and personal purposes the internet has become a target for malicious users and criminals. Criminals, attackers, malicious hackers, or simply hackers often seek to infiltrate computer systems to interrupt operations, steal information, perform espionage, sell unwanted services, hijack processing operations, redirect commercial traffic, and the like. Harm from hackers can range from activities that are mildly harmful such as installing unwanted software on a computer or causing slowed performance to extremely harmful activities such as theft of national secrets, identity theft, or the like.

In particular large and or important networks such as those owned by retailers, corporations, payroll operations, banks, utilities, government agencies can easily attract the attention of hackers. However, even small operations are not immune from attack. Small operations are often a target to try to infiltrate first, as they may have less security, and serve as practice for the hacker in developing their infiltration techniques. Often a service provider such as a payroll service can provide a backdoor entry to the service provider who is the real target for a hacker that has breached the security of an inattentive or lax service provider. As can be seen as commerce and business increasingly use computer networks they may look for new ways to thwart criminals and other undesirables attempting to interfere with the operation of their computer networks.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present examples of collaborative and proactive defense of networks and information systems provides a way of protecting computer networks from hackers by stopping them from entering: a protected network, protected associated networks, and devices. Protections may be include processes that provide communications between layers in a communications protocol stack, or its equivalent structure, to identify and stop threats. Protection is bidirectional. Threats identified include those entering, or attempting to enter a network or device, and those threats leaving a network (such as traffic being redirected). Identified threats may be profiled and stored in a local and/or network database that may be shared among other subscribers, or networks. Once a threat is identified it may be blocked, redirected or otherwise processed to thwart, identify, or otherwise deal with the threat. Such protection may be termed the collaborative and proactive defense of networks and information systems.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a block diagram of a conventional computer network that may be vulnerable to an attack.

FIG. 2 is a block diagram of a computer network having collaborative and proactive defenses that may include hardware systems and various proactive and collaborative processes.

FIG. 3 is a block diagram of a hardware system for a computer network having collaborative and proactive defenses.

FIG. 4 is a process flow diagram of a proactive and collaborative process for a computer network having collaborative and proactive defenses.

FIG. 5 shows an exemplary layered programming structure (“stack”) x01 that can be utilized in providing networking capabilities for a computer network having collaborative and proactive defenses.

FIG. 6 illustrates an exemplary computing environment ×00 in which computer network having collaborative and proactive defenses described in this application, may be implemented.

Like reference numerals are used to designate like parts in the accompanying drawings.

### DETAILED DESCRIPTION

The detailed description provided below in connection with the appended drawings is intended as an exemplary description and is not intended to represent the only forms in which the computer network having collaborative and proactive defenses may be constructed or utilized. The description sets forth the functions of the example and the sequence of steps for constructing and operating the example. However, the same or equivalent functions and sequences may be accomplished by different examples.

The examples below describe collaborative and proactive defense of networks and information systems. Although the present examples are described and illustrated herein as being implemented in a simplified system, the system described is provided as an example and not a limitation. As those skilled in the art will appreciate, the present examples are suitable for application in a variety of different types of networked systems of varying complexity and configurations utilizing various equivalent communications protocols.

Collaborative and proactive defense of networks and information systems allows one or more networks and/or information systems to collaboratively defeat attacks by combining the network layer and application layer (based on the OSI model or equivalent) via a common storage and communication mechanism. By identifying an attacker and collaborating with other network and/or information systems the attacker is stopped typically immediately upon their first detected attack typically allowing all of the networks and/or information systems to avoid attacks that might otherwise be successful.

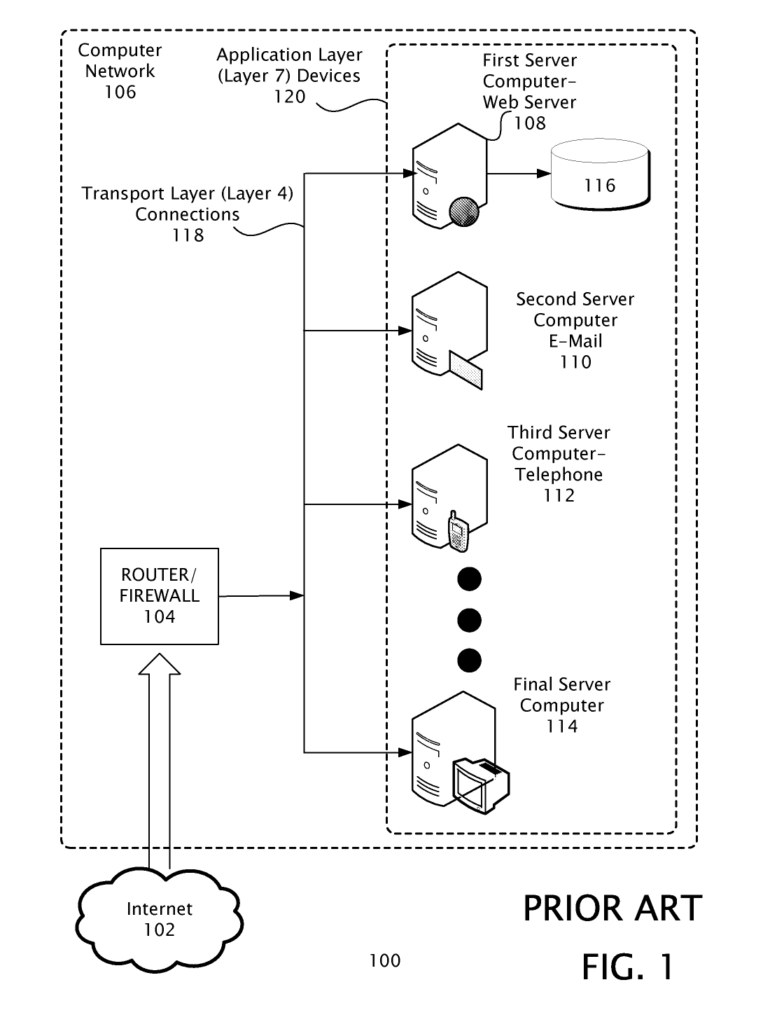

FIG. 1 is a block diagram of a conventional computer network environment 100 that may be vulnerable to an attack. As shown the internet 102 may be coupled to a computer network 106 through a router and or firewall 104. The router/firewall 104 may then be coupled to a plurality of servers 108, 110, 112, 114 that provide various functions to other users (not shown) within the network 106. As shown the router firewall 104 may be coupled to a web server computer 108, an e-mail server 110, a communications, or telephone server 112, or any other type of computing device that may be found in such a network. One or more databases 116 may be coupled to the network 106 to store information that may be needed for the operation of the network 106. For example a local data base 116 may be coupled to the web server 108.

Network 106 is representative of the various kinds that may be constructed to link computer users together within a common group of users. The network shown is suitable for users such as corporate users, e-tailers, personal use, and the like. Such a network may also provide access to computing devices outside the network 106, typically providing access through a router/firewall 104 to the internet 102.

Conventionally constructed router/firewall 104 may be provided to secure the network 106 typically by limiting the number of ports presented to the internet 102. The router/firewall may provide typical routing of traffic and may also provide a firewall as a first line of defense to attempt to secure the network 106 from security breaches. However, as information systems have developed many communications ports may be provided, or native to, other devices 108, 110, 112, 114 that may allow threats to penetrate the computer network 106 without being filtered out by the router/firewall 104. Coupled to or behind the firewall may be a number of devices 108, 110, 112, 114 may provided to render services to various internal and external users.

For example a web server 108 may run web applications to provide a webpage to external (internet) or internal (intranet) customers, and may host an e-commerce site that takes orders and then processes them for fulfillment. Data typically taken from e-commerce transactions may be stored on one or more databases 116 while the transaction is being processed, or may remain there for use in future orders client lists, warranty information, and the like. Similar data bases may be provided behind, or otherwise coupled to (or shared with), any of the other services 110, 112, 114, that are provided.

The e-mail server 110 typically directs e-mail flow to and from the network 106. The telephone or telecommunications server 112, may provide VoIP or other telecommunications services. And finally, any other server or device present 114 may perform services that may be included in such a network 106. In such a network these servers, databases, and other uses within it may be subject to attack, as the firewall 104 may not always be effective in preventing intrusions.

Intrusions may be classified according to their objectives. Types of attack include denial of service attacks, penetration attacks, and financial saturation attacks. A typical denial of service attack on network 106 may originate from the internet 102 and may be aimed at the router/firewall 104 in an effort to bring it down. The network is prevented from communicating by saturating the router 104 with requests for service from an external source, so that the router 104 is so busy processing these requests that legitimate traffic is blocked, or otherwise disrupted from entering or leaving the network 106.

In an alternate form of a denial of service attack, a hacker may get past the router 104 and attack another one or more of the internal servers 108, 110, 112, 114, such as web server 104 that may not be able to process as much traffic. This kind of attack may not be effective if the router 104 is very robust and able to handle the onslaught of service requests targeted at it. The hacker may try to go after a weaker element of the network 106 if he is able to get past the firewall 104. For example if the web server 108 can not handle as many transactions as the router/firewall 104 then the hacker may attempt a denial of service attack there.

In an e-commerce application an attack against the web server 108 would prevent customers from finding the e-commerce provider-denying the retailer their web presence or otherwise blocking business from being transacted.

Attacks against phone systems, such as those including telephone server 112 can include the blockage of services as previously described, but also transfers of service to unauthorized users and the like. Such attacks not only cause interruptions to a companies ability to transact business, but also cause customers to loose faith in the companies ability to securely transact business with them, especially if their call is rerouted to an unintended party.

Different attackers may have different objectives leading to the formation of different attack strategies, such as a penetration attack.

For example state actors (cyber warfare), or corporate spies are typically more interested in accessing data stored on a computer network, or in taking control of it rather than misdirecting traffic, or interfering with operations as a typical attacker might be interested in doing. State, or corporate, actors may also be interested in learning who is talking to whom within a network in an effort to create a list of targets for further exploitation in another more secure network.

For example a hacker may have as an ultimate goal to-hack into a Department of Defense or a government agency computer network. However the security may be too stringent for them to get in by a frontal attack. They may try a weaker link, such as a contractor, first trying to find a way in, or in hope that some critical or competitive information has bled down from the more secure system to the less secure system. A similar situation could occur in a corporate setting. The corporate computer network may be well protected, but a payroll services company, an order fulfillment enterprise, or any of the other contractors that have had work outsourced to them may provide a way in to the corporate computer network.

Finally, in the financial saturation attack a corporation may use a storefront in its operations. The storefront is typically a computer network that the corporate computer communicates with as it has offloaded some of its tasks to the storefront perhaps on a subscription basis. Typically the corporation may pay the storefront a fee based on how many times the storefront is accessed. If a hacker can determine how to use the storefront, possibly by determining transaction IDs, then that hacker can repeatedly access the storefront driving up the bill to the corporation. Thus in the financial saturation attack a business can no longer protect its commercial conduit or relationship with its service provider. Competitors may be motivated to engage in this type of attack to burden a competitor with bills for services that burden it to the point of extinction. In general terms these various attacks effectively cause denial of use of a resource, exploitation of a resource, and overuse of a resource for negative commercial purposes.

The connections shown in the diagram form a connective network and may be considered to be established, or represented, by the network transport layer of a transportation protocol model such as layer four the OSI model, or its equivalent transport protocol model. The transport layer may provide access to the various devices that may be disposed on the computer network.

Typically available security systems may be supplied as an add-on service that monitors the network. They may monitor either or both of layers four or seven. Currently available security systems tend to independently protect either layer four, or layer seven, but do not tend to share information between the layers. The conventional security tends to function as independent protection for each layer. For example if a device whose operation is governed under the application layer is under attack, the transport layer typically does nothing to interrupt the attack, and is not even aware of the attack. Thus the transport layer in such a situation simply allows the attack to continue, even after a device signals that it is under attack since there is no communications between layers.

Also, once the network transport layer 118 identifies a hacker that layer typically does nothing to alert devices in the network governed by layer seven 120 to the identity of a hacker, and that the device should not communicate with that identified hacker. Security systems may rely on a human to monitor each layer (“sneaker net”), and typically by the time the security service realizes that an attack has occurred, the attack is typically over, and the damage done.

Finally, in typical security systems there is typically no communication between related networks to convey information that an attack is occurring in another location, or to transmit the identity of the threat. Related users have no indication that they might be next to be attacked. Accordingly typical security systems may be disadvantaged in their ability to react, speed to react, and effectiveness of reaction for the reasons described above.

Such a conventional system, or a conventional system equipped with the currently available security systems, may be especially prone to the previously described types of hacker attacks. These types of attacks and others may be thwarted by a network providing proactive defense of networks and information systems described in the following figures.

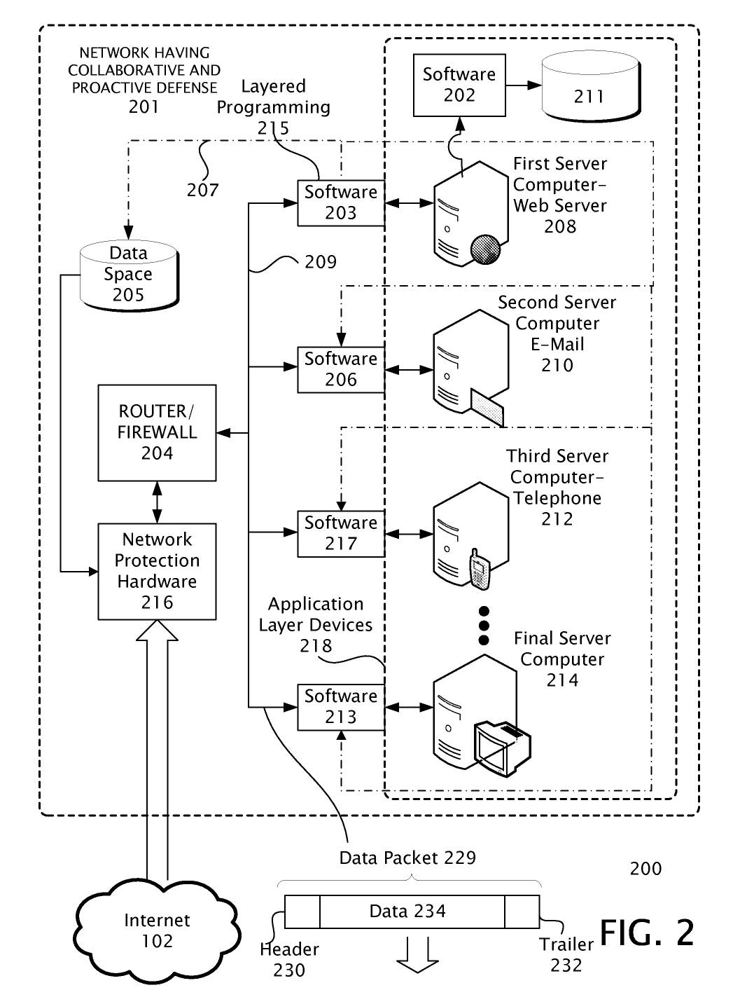

FIG. 2 is a block diagram of a computer network 201 having collaborative and proactive defenses that may include hardware systems and various proactive and collaborative processes 203, 208, 213, 217. The exemplary network 201 is shown in an exemplary internet environment 200. Such a network 201 may include two or more security functions: proactive defense and collaboration. First, proactive defense is provided by identifying threats in advance and communicating from the application layers to the transport layers to stop the movement of harmful traffic before it does damage. In this system the application layers (layer 7) devices 218 and the transport layers (layer 4) interconnections 209 may work together as a single entity.

For example if the web server 208 raises an alert that it is being attacked, the network providing proactive defense of networks and information systems can interrupt the attack 216 by denying access to the computer network 201 through disconnection from transport layer 209. Second, this system may collaborate by sharing the information it has learned and stored 205 about potential attacks to inform not only other layers, but also other networks and devices in a collaborative fashion to thwart attackers.

In particular the computer network having collaborative and proactive defenses may include a network protection hardware device 216, and software (alternatively “applications system”) 202, 203, 206, 213 217, and a shared data space 205. The software 202, 203, 206, 213 217 may be disposed on a part of the application layer devices 218, to collaborate and identify attackers and determine attacker information, and shares that information via communications 207 with a data space 205.

Data space 205 may be a hardware device, a virtual database distributed over one or more networks, or any equivalent data base or device in which data may be communally stored, or retrieved. As shown in the figure data space 205 may be coupled via any convenient path to software 202, 203, 206, 213 21 7 disposed upon each device 208, 210, 212, 214 so that the identity and information on an attacker determined by these devices may be communicated 207 from applications software 202, 203, 206, 213 217 to the data space 205. Or, the software 202, 203, 206, 213 217 may determine the identity of attacker by consulting the data space 205.

By consulting the data space 205 each device 208, 210, 212, 214 may use the information to take its own measures to protect it's self from attack. Alternatively and in addition to these steps network protection hardware 216 may, operating under control of data space 205 block an attacker from entering the network having collaborative and proactive defenses 201. Each system may utilize it software 202, 203, 206, 213 217 to optimally determine if it is under attack, and then share information about a flagged attacker with other devices in the network, and also other networks (not shown).

In sharing information with other networks the data space 205 may be duplicated, located remotely either as an actual data base, or as a virtually constructed database constructed with data linked 207 from other devices. Data space 205 may also receive updated information on the identity of threats from other affiliated or associated computer networks for local use.

Data space 205 may also be equivalently considered to be an aggregated data base made up of localized data bases which may be associated with other devices in the network. An example is the data base 211 associated with the first server computer 208. Local data base 211, and other data bases present may replicate the data present on data space 205 individually so that the effect is as if there is a single equivalent data space 205 communicatively coupled to each device in the network 208, 210, 212, 214 having proactive and collaborative defenses.

Updates allow data space 205 to spread their information to as many devices as possible within the network 201, or to affiliated networks being protected. Updates to the various databases may typically be made as attacks are detected, or shortly there after. Typically the data base of the device under attack is updated first, then the updated information may be replicated throughout the network through any suitable transmission method. Attack information updates to the data base may also be made on a timed basis, or by any suitable update method. In further alternative examples, updates may be made via any suitable channel such as back-links that may include telephone lines, wireless links or the like. The database 211 may also include software 202 coupled to it for collecting and distributing information on potential attackers.

Software 202, 203, 206, 213 217 may be somewhat modularized in that it has common elements or functionalities that may be utilized, for example the mechanisms for data base updates. However, each device, and the attacks that may be perpetrated against each device are somewhat unique in nature and may require a degree of software modification, or unique coding to recognize and deal with threats directed against it. This can allow for tailored analysis, as each software module 202, 203, 206, 213 217 provided for each device can be optimized to detect specific threats and identify them to the network 201 and other affiliated networks, effectively increasing the sensitivity of the network to attacks.

An example of a process 203 that may deal with an attack is software designed for detecting an attacker of a web server. A web server may typically provide a home page, login page and a report page. An attacker may decide to attack the web server and to do so must login. An attacker would typically attempt a number of attempts to break in by varying the login until a successful login is obtained and the security is breached. The software of layer seven may keep track of the number of log ins and decide that an attacker is attempting access after a certain number of login attempts have been made.

The attacker's IP address may be found from examining the header, or relevant area, of a data packet received by the web server. So in each login attempt the web server keeps track of the sender, and if a predetermined number of logins are attempted the sender is labeled a risk and his IP address is stored in the database for future reference. From the local data base 211 the IP address is communicated to the other data bases in the instant network and other affiliated networks. When the IP address, or relevant source address, identified as bad is detected at any other network it is blocked, or if it should get past the network protection hardware 216, it will be identified at the device and blocked there.

Further on the network layer the attacker address may be made available to it, and if an attacker approaches on the network layer, for example attempting a port scan of the network. The packet containing the port scan command in the payload is first examined. If the known attacker's address if found in the packet then the attacker's port scan may be blocked at the network layer.

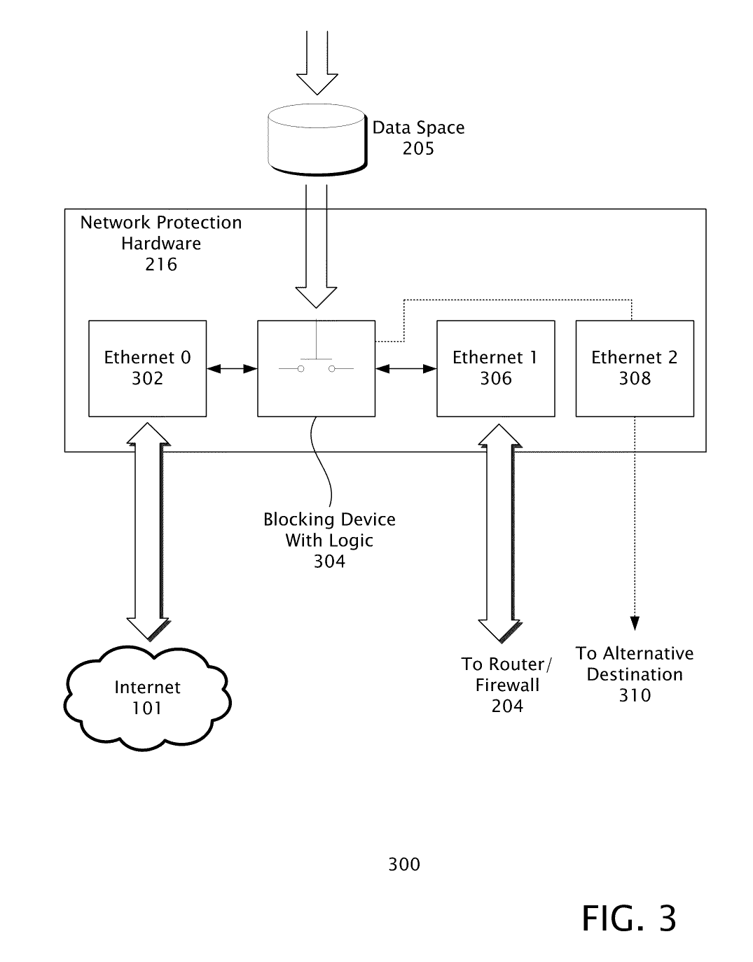

FIG. 3 is a block diagram of network protection hardware 216 for a computer network having collaborative and proactive defenses. Network protection hardware 216 may include any type of computing device. For example network protection hardware 216 could be a telephone, PC, a computer at a well drilling site, or the like.

Exemplary network protection hardware 216 acts as a bridging device between the internet 101 and the network devices typically coupled to it through the router/firewall 204 which may be coupled to the network protection hardware 216. internal to the network protection hardware 216 is a blocking device 304 that may be constructed as a logic circuit or its equivalent.

Blocking device 304 has an input coupled to the internet via the exemplary Ethernet 0 port, and an output coupled to the router firewall 204 through the exemplary Ethernet 1 port. Blocking device 304 may act to disrupt and/or reroute internet traffic that has been identified as a threat at a transport layer level of functionality. For example the blocking device 304 monitors incoming (and outgoing) traffic comparing it to a profile, or list of known or suspected attackers from the data space 205. If there is a match the incoming (or outgoing) internet data is blocked, or diverted keeping the attacker from entering the network (201 of FIG. 2) or from sending information to an attackers address.

Alternatively if a threat is detected the attacker may be diverted to another port such as the exemplary Ethernet 2 port, from there the attacker may be rerouted to an alternative destination 310.

An alternative destination might be a network that is identical to the one being attacked (a cloned network), with the exception that the only traffic being directed to it is that of suspected hackers. In this identical network the attack may be further analyzed to gain useful information on the attackers strategy and identity. In such an arrangement an attacker might be deceived into thinking he has breached the actual network, and if he publically declares victory his identity may become known without his actually breaching a vital network. Alternatively false information can be forwarded to the attacker to mislead them.

The blocking device 216 may be a process implemented by hardware, firmware, or software running on a processor. The process compares and analyzes the incoming traffic by comparison to the data base. Alternatively, a potential attacker may be identified in the data base as suspect, and if for a period of time no more suspected attacks occur then he might no longer be blocked from the network. In an alternative example of processing the incoming traffic may be broken apart for analysis, and if a threat is detected the traffic may be stopped, and the sender identified. Thus, the blocking device 304 is capable of identifying and stopping attackers, and identifying and stopping known patterns of attack.

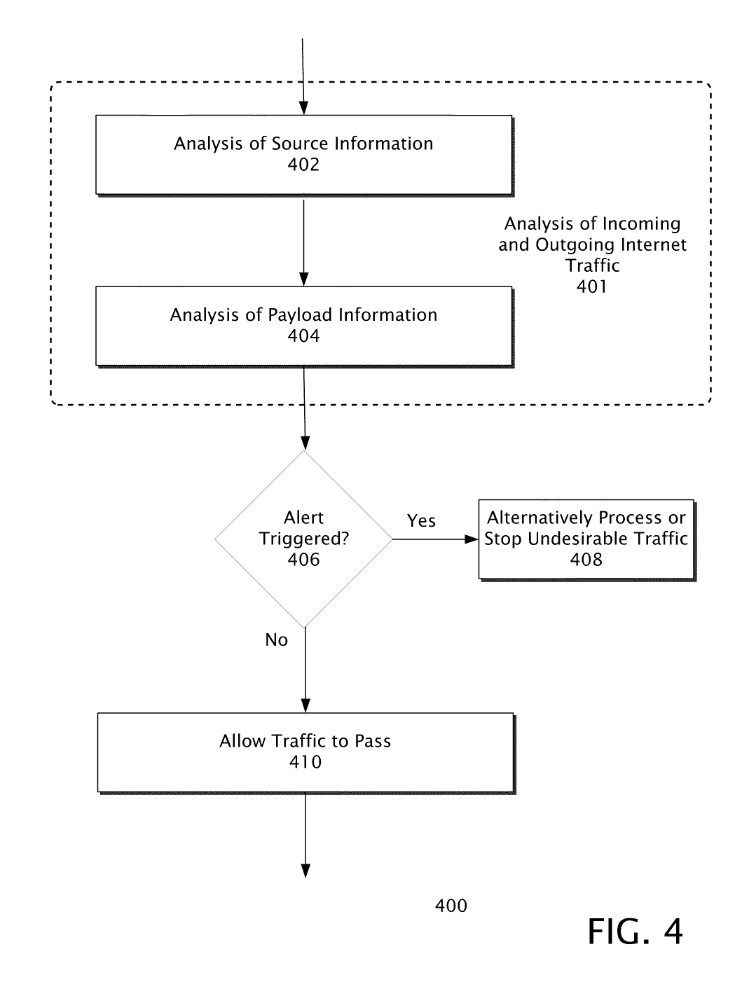

FIG. 4 is a process flow diagram 400 of a proactive and collaborative process for a computer network having collaborative and proactive defenses. Initially the analysis of incoming and/or outgoing internet traffic is performed 401. Analysis of incoming and/or outgoing internet traffic 401 may include Analysis of source information 402, and analysis of payload information 404.

At block 402 analysis of source data from the internet is performed. Source information analyzed may include IP address, MAC address, connection port (ports that are dedicated to traffic from a particular customer), and the like. Principally, the source location is sought to be determined in this block.

Analysis as described in blocks 402 and 404 may utilize a programming construct called creating a proxy to apply logic and then block or allow traffic to pass at block 406. Alternatively the technique may be termed creating a repeater. In a further alternative example in the network layer hardware may provide the desired logic where a memory array may provide logic to either pass or block a signal, typically on generation of a logic one or zero as a control signal to a logic gate.

At block 404 analysis of payload information of incoming internet data is performed. Payload analysis typically includes a list of various items to look for in the payload that may have been determined to be indicative of an attack. Items looked for can be any payload information that has been flagged as a potential threat. Pattern matching techniques may be used to match items in the payload to the known, tabulated, or otherwise cataloged items. Alternatively, the items need not be an exact match. If a certain degree of correlation is found the item may be flagged as an attack also. The degree of correlation looked for can be based upon how much risk for attack is tolerable to the network administrator. Once a questionable item is found an alert may be generated.

In a further alternative example known or suspected bad domains may be looked for in traffic leaving the network. A bad domain name may be indicative of an attack that has met with a degree of success, and that is now attempting to divert traffic, or send information to a known bad domain. The network protection hardware (216 of FIG. 2) is bidirectional and may prevent such traffic from leaving the network (201 of FIG. 2).

At block 406 a determination of whether an alert is to be triggered is made. If the alert is to be triggered alternative processing or stoppage of the undesirable traffic 408 is performed. If an alert is not to be issued, or triggered, then the traffic is allowed to pass through as shown at block 410.

A computer network having collaborative and proactive defenses is typically an interconnection of a group of computers with communications and processing facilitated by computer programming (202, 203, 206, 213, 217 of FIG. 2), typically implemented in a layered structure that that includes functions for assembling packets of data (229 of FIG. 2) for transmission, transmitting the data, and then extracting or reassembling the data. A layered structure can allow for an ordered and logical implementation of computer processes and communications by compartmentalizing related processes, and providing known interfaces between processes.

Various layered structures may be used equivalently in implementing a proactive and collaborative process for a computer network having collaborative and proactive defenses. The four layer Internet Protocol (“IP”) model is an example. The seven-layer Open Systems Interconnection (“OSI”) reference model is another example. A number of networks use the Internet Protocol as their network model, however the seven layer (Application, Presentation. Session, Transport, Network, Data Link, and Physical Layers) OSI model or the like, may be equivalently substituted for the four layer (Application, Transport, Network and Data Link Layers) IP model. In further alternative examples different layered program structures for networking may be provided that provide equivalent interconnection capabilities.

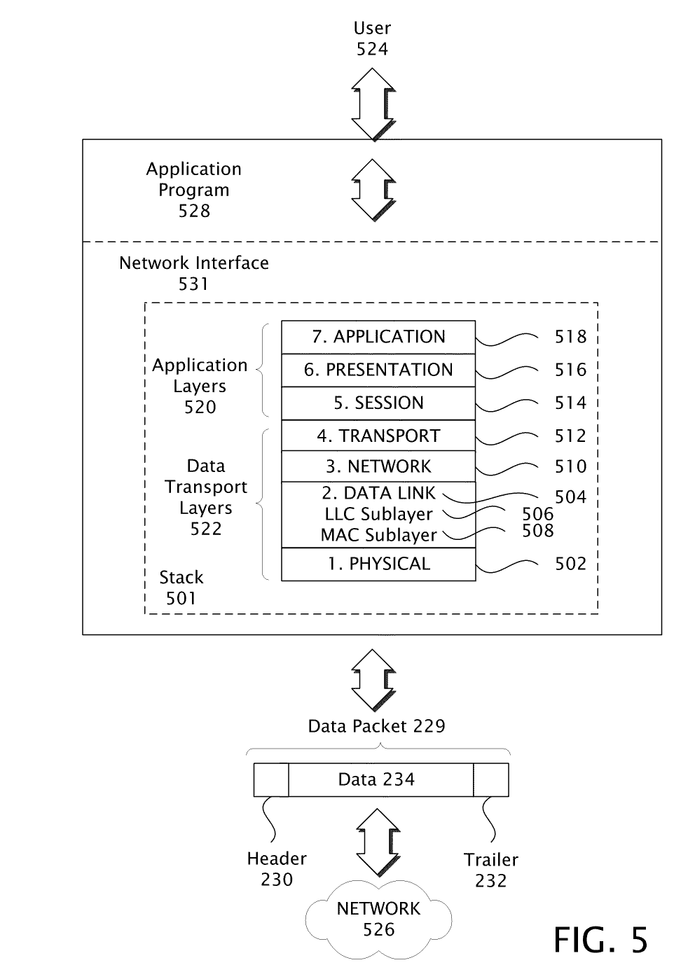

FIG. 5 shows an exemplary layered programming structure (“stack”) 501 that can be utilized in providing networking capabilities for a computer network having collaborative and proactive defenses. Application programs 518 typically do not couple directly to a network 526. They may often couple to a network 526 through a layered programming structure 501 that facilitates networking, without placing undue programming burdens on the application program 518. Each layer 502, 504, 506, 508, 510, 512, 514, 516, 518 can be written somewhat independently for a particular network implementation which, also tends to simplify providing software networking functions.

Programming 518 that may wish to provide network connectivity 526 can be implemented by providing programming in an exemplary layered structure 501. The exemplary Open Systems Interconnect (“OSI”) model 501 is an exemplary abstract description for communications and computer network protocol design. The OSI model describes how information from a software application 518 in one computer moves through a network medium 526 to a software application in another computer (not shown).

The OSI model 501 divides tasks involved with moving information between networked computers into smaller, more manageable task groups arranged in layers 502, 504, 506, 508, 510, 512, 514, 516, 518. In general an OSI transport layer 502, 504, 506, 508, 510, 512 is generally capable of communicating with three other OSI layers, the layer directly above it, the layer directly below it, and its peer layer in another computer that it is coupled to. Information being transferred from a software application 518 in one computer system to a software application in another (not shown) must usually pass through the application layers 520 to the transport layers 522 where it may be readied for transport, before actual transfer occurs.

A task or group of tasks can be assigned to each of the OSI layers 502, 504, 506, 508, 510, 512, 514, 516, 518. Each layer can be set up to be reasonably self-contained so that the tasks assigned to each layer can be implemented independently. Layering also enables the tasks implemented by a particular layer to be updated without adversely affecting the other layers. The exemplary OSI model 501 can be structured in layers that can include an:
1. Application layer 518;
2. Presentation layer 516:
3. Session layer 514;
4. Transport layer 512;
5. Network layer 510;
6. Data Link 504; and a
7. Physical layer 502.

A layer can be a collection of related functions, that provide services to the layer above it, and is provided with services from the layer below it. The listed layers and functions are exemplary only. For example more or fewer layers may be provided, and the functions of the layers may vary depending upon the application.

The application layers 520 may be in communication with an application program 528. To communicate information from, or regarding, the application program 528 the application layer 520 can generate information units 534 that may be passed to one or more of the data transport layers 522 for encapsulation 529 and transfer across the network 526. Each of the three uppermost transport layers 504, 510, 512 can generate its own header 530, trailer 532 and the like to pass information units and data 534 generated from above across the network 526. The lowest transport layer, the physical layer 502 simply transports data from one or more of the higher layers 504, 506, 508, 510, 512, 514, 516, 518 and does not generate its own header, trailer or the like.

1. The Physical layer 502: The physical layer is typically hardware and software which can enable the signal and binary data transmission (for example cable and connectors). Definition provided by the physical layer can include the layout of pins, voltages, data rates, maximum transmission distances, cable specifications, and the like.

In contrast to the functions of the adjacent data link layer 504, the physical layer 502 primarily deals with the interface of a device with a medium, while the data link layer 504 is concerned more with the interactions of two or more devices with a shared medium.

2. The Data Link layer 504: The Data Link layer 504 is typically software and hardware which can provide physical addressing for transporting data across a physical network layer 502. Different data link layer specifications that may be implemented in this layer can define different network and protocol characteristics, including physical addressing, network topology, error notification, sequencing of frames, and flow control. Physical addressing in this layer (as opposed to network addressing) can define how devices are addressed from this data link layer 504. Network topology consists of the data link layer specifications that often define how network devices are to be physically connected, such as in a bus topology, ring topology or the like. The data Link layer 504 can provide the functional and procedural means (headers and trailers) to transfer data between network entities, and to detect and possibly correct errors that may occur in the physical layer 502. This layer 504 may be divided into two sub layers 506, 508 if desired:

The Logical Link Control (“LLC”) Sub-layer 506 can refer to the highest data link sub-layer that can manage communications between devices over a single link of a network.

Media Access Control (MAC) sub-layer 508 can refer to the lowest data link sub-layer that can manage protocol access to the physical network medium 526. It determines who is allowed to access the medium at any one time.

3. The network layer 510 can provide path determination and logical addressing. The network layer 510 may define the network address (different from the MAC address). Some network layer protocols, such as the exemplary Internet Protocol (IP) or the like, define network addresses in a way that route selection can be determined. Because this layer 510 defines the logical network layout, routers can use this layer to determine how to forward packets.

The network layer 510 can provide the functional and procedural means of transferring variable length data sequences from a source to a destination while maintaining the quality of service requested by the transport layer 512 immediately above. The network layer 510 performs network routing functions, and might also perform fragmentation and reassembly of data, and report data delivery errors. Routers can operate at this layer 510, by sending data throughout the extended network and making the Internet possible.

4. The transport layer 512 can provide transparent transfer of data between end users, providing reliable data transfer services to the upper layers. The transport layer 512 accepts data from the session layer 514 above and segments the data for transport across the network 526. In general, the transport layer 512 may be responsible for making sure that the data can be delivered error-free and in proper sequence. Exemplary transport protocols that may be used on the internet can include TCP, UDP or the like.

5. The session layer 514 can provide Inter-host communication. The session layer 514 may control the dialogues/connections (sessions) between computers. It establishes, manages and terminates the connections between the local 518 and remote application (not shown). It provides for full-duplex, half-duplex, or simplex operation, and can establish check-pointing, adjournment, termination, restart procedures and the like. Multiplexing by this layer 514 can enable data from several applications to be transmitted via a single physical link 526.

6. The presentation layer 516 can provide functions including data representation and encryption. The presentation layer 516 can establish a context between application layer entities, in which the higher-layers can have applied different syntax and semantics, as long as the presentation service being provided understands both, and the mapping between them. The presentation service data units are then encapsulated into Session Protocol Data Units, and moved down the stack.

The presentation layer 516 provides a variety of coding and conversion functions that can be applied to data from the application layer 518. These functions ensure that information sent from the application layer of one system would be readable by the application layer of another system. Some examples of presentation layer coding and conversion schemes include QuickTime, Motion Picture Experts Group (MPEG), Graphics Interchange Format (GIF), Joint Photographic Experts Group (JPEG), Tagged Image File Format (TIFF), and the like.

7. The application layer 518 can link network process to application programs. The application layer interfaces directly to and performs common application services for the application processes; it also issues requests to the presentation layer 516 below. Application layer 518 processes can interact with software applications programs that may contain a communications component.

The application layer 518 is the uppermost layer and thus the user and the application layer can interact directly with the software application. Examples of application layer functions include Telnet, File Transfer Protocol (FTP), Simple Mail Transfer Protocol (SMTP), and the like.

The original architecture of the OSI model can be representative of network architectures that may be designed, and it is provided as an example of many possible architectures that the process described herein may be applied to. Newer equivalent IETF and IEEE protocols, as well as newer OSI protocols have been created, and may equivalently be utilized in the examples described herein. Thus, a particular protocol may be designed to fit into other standards having differing numbers of layers (for example the five layer TCP/IP model) and the like.

A process such as that described herein may equivalently implemented in other suitable layers or sub layers as will be appreciated by those skilled in the art. In particular programming within a layer can be very free flowing and unstructured to achieve a particular task, or process such as the collaborative and proactive defense of networks and information systems described herein. However, the programming governing relationships between various layers tends be more structured to facilitate between-layer communications by invoking known processes, and protocols.

Not all layers of the OSI model or its equivalent may necessarily be used. For example WAN networks generally function at the lower three layers of the OSI reference model: the physical layer, the data link layer, and the network layer to provided the desired functions of a WAN network.

A layered process or protocol is also useful because a process (such as those being executed in each layer) may divide itself into multiple threads that can execute in parallel. Threads usually run different instructions using substantially the same resources and data. Threads can be a way for a program to fork (or split) into two or more simultaneously (or pseudo-simultaneously) running tasks. For example threading allows a single processor to apparently do two things at one time. For example a process such as a media player may play music, and a process such as a spread sheet may appear to run simultaneously. Actually the typically single processor in the CPU is switching between processes at a fast rate so that the processes appear to run simultaneously. On a multiprocessor or multi-core system, threading can be achieved via multiprocessing, wherein different threads and processes can run simultaneously on different processors or cores.

Each process can have several threads of execution (“threads”). Multiple threads share the same program code, operating system resources (memory, file access and the like) and operating system permissions (for file access as the process they belong to). A process that has only one thread can be referred to as a single-threaded process, while a process with multiple threads is referred to as a multi-threaded process. Multi-threaded processes can perform several tasks concurrently without the extra overhead needed to create a new process and handle synchronized communication between these processes. For example a word processor can perform a grammar and spell check as the user types. In this example, one thread handles user input, while another runs the spell checking utility, and a third runs the grammar checking utility.

Internet communications protocols being implemented by a layered programming structure may communicate with other processes (and hardware) by exchanging pieces of information disposed in packets. The lower layers of a layered programming structure may be used to collect and format data into packets. A packet is typically a sequence of bytes having a header followed by a body. The header describes the packet's destination and possibly routers to use for forwarding the packet until it arrives at its final destination. The body contains the data or payload which the internet protocol is transmitting.

Due to network congestion, traffic load balancing, or other uncertainties in transmission, IP packets can be lost or delivered out of order. A layered transmission control protocol can detect these problems and request retransmission of lost packets, rearrange out of order packets, and the like. Once the transmission control protocol of the receiver has reassembled a copy of the data originally transmitted, it may pass that data to an application program.

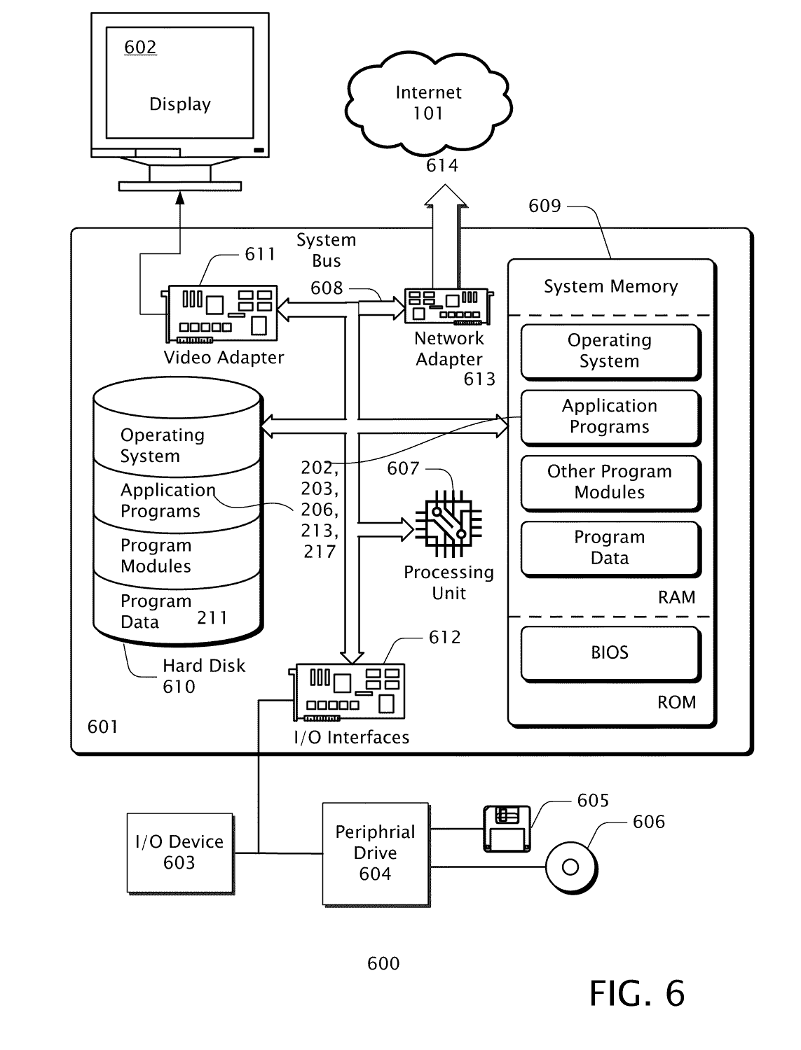

FIG. 6 illustrates an exemplary computing environment 600 in which computer network having collaborative and proactive defenses described in this application, may be implemented. It is representative of the architecture of the various devices (208, 210, 212, 212, 214 of FIG. 2) of the network (201 of FIG. 2) Exemplary computing environment 600 is only one example of a computing system and is not intended to limit the examples described in this application to this particular computing environment or specific construction. In particular consumer electronics devices may be much simpler, and other devices such as VoIP systems may have additional conventionally constructed features.

For example the computing environment 600 can be implemented with numerous other general purpose or special purpose computing system configurations. Examples of well known computing systems, may include, but are not limited to, personal computers, hand-held or laptop devices, microprocessor-based systems, multiprocessor systems, set top boxes, gaming consoles, consumer electronics, cellular telephones, PDAs, and the like.

The computer 600 includes a general-purpose computing system in the form of a computing device 601. The components of computing device 601 can include one or more processors (including CPUs, GPUs, microprocessors and the like) 607, a system memory 609, and a system bus 608 that couples the various system components. Processor 607 processes various computer executable instructions, including those to execute a process of providing a collaborative and proactive defense of networks and information systems under control of computing device 601 and to communicate with other electronic and computing devices (not shown). The system bus 608 represents any number of several types of bus structures, including a memory bus or memory controller, a peripheral bus, an accelerated graphics port, and a processor or local bus using any of a variety of bus architectures.

The system memory 609 includes computer-readable media in the form of volatile memory, such as random access memory (RAM), and/or non-volatile memory, such as read only memory (ROM). A basic input/output system (BIOS) is stored in ROM. RAM typically contains data and/or program modules that are immediately accessible to and/or presently operated on by one or more of the processors 607.

Mass storage devices 604 may be coupled to the computing device 601 or incorporated into the computing device by coupling to the buss. Such mass storage devices 604 may include a magnetic disk drive which reads from and writes to a removable, non volatile magnetic disk (e.g., a “floppy disk”) 605, or an optical disk drive that reads from and/or writes to a removable, non-volatile optical disk such as a CD ROM or the like 606. Computer readable media 605, 606 typically embody computer readable instructions, data structures, program modules and the like supplied on floppy disks, CDs, portable memory sticks and the like.

Any number of program modules can be stored on the hard disk 610, Mass storage device 604, ROM and/or RAM 6-9, including by way of example, an operating system, one or more application programs, other program modules, and program data. Each of such operating system, application programs, other program modules and program data (or some combination thereof) may include an embodiment of the systems and methods described herein.

A display device 602 can be connected to the system bus 608 via an interface, such as a video adapter 611. A user can interface with computing device 702 via any number of different input devices 603 such as a keyboard, pointing device, joystick, game pad, serial port, and/or the like. These and other input devices are connected to the processors 607 via input/output interfaces 612 that are coupled to the system bus 608, but may be connected by other interface and bus structures, such as a parallel port, game port, and/or a universal serial bus (USB).

Computing device 600 can operate in a networked environment using connections to one or more remote computers through one or more local area networks (LANs), wide area networks (WANs) and the like. The computing device 601 is connected to a network 614 via a network adapter 613 or alternatively by a modem, DSL, ISDN interface or the like.

Those skilled in the art will realize that the process sequences described above may be equivalently performed in any order to achieve a desired result. Also, sub-processes may typically be omitted as desired without taking away from the overall functionality of the processes described above.

Those skilled in the art will realize that storage devices utilized to store program instructions and data can be distributed across a network. For example a remote computer may store an example of the process described as software. A local or terminal computer may access the remote computer and download a part or all of the software to run the program or download data as needed. Alternatively the local computer may download pieces of the software as needed, or distributively process by executing some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

1. A security system comprising:
network protection hardware; and
a data space coupled to the network protection hard ware for stopping a network attack.
